(19) United States
(12) Patent Application Publication
(10) Pub. No.: US 2026/0077980 A1
(43) Pub. Date: Mar. 19, 2026

(54) CRANE ARRANGEMENT

(71) Applicant: HIAB AB, Malmö (SE)

(72) Inventors: David Näslund, Täby (SE); Lars Rydahl, Hudiksvall (SE); Mattias Berglund, Hudiksvall (SE)

(73) Assignee: HIAB AB, Malmö (SE)

(21) Appl. No.: 19/327,051

(22) Filed: Sep. 12, 2025

(30) Foreign Application Priority Data
Sep. 19, 2024 (EP) 24201346.4

(51) Int. Cl. B66C 15/04; B66C 13/20; B66C 13/46; B66C 15/06; B66C 23/36

(52) U.S. Cl. CPC B66C 15/045; B66C 13/20; B66C 13/46; B66C 15/065; B66C 23/36

(57) ABSTRACT

Crane arrangement arranged in relation to a vehicle, the crane arrangement comprising a movable arm comprising a plurality of crane booms including a final crane boom with a crane boom tip; a crane manoeuvring unit arranged to generate crane operation commands, such as commands for movements of the movable arm, based on received crane operation inputs by an operator of the crane arrangement; a distance measurement arrangement configured to measure and determine a straight line working distance between said crane manoeuvring unit and a predetermined location at said movable arm, and to generate a distance signal in dependence thereto, and a crane controller arranged to monitor and control the movements of the movable arm in response to crane operation commands received from the crane manoeuvring unit and of said distance signal from the distance measurement arrangement. The crane controller is configured to compare the working distance to a first predetermined safety distance, and if said working distance is shorter than said first predetermined safety distance, the crane controller is arranged to stop crane movements. The manoeuvring unit is configured to receive, from the operator, a crane operation input for continued operation, and if it is determined that said working distance is shorter than said first predetermined safety distance and if a crane operation input for continued operation is received by said manoeuvring unit, the crane controller is arranged to activate a cautious operation mode that enables restricted movements of the movable arm defined by a set of movement limitation rules.

### TECHNICAL FIELD

The present invention relates generally to crane arrangements for vehicles, specifically to a crane arrangement that enhances operational safety and control by utilizing distance measurement capabilities along with operator input to manage the movements of the crane. The crane arrangement is particularly applicable to a truck-mounted loader crane for loading and unloading a load to the truck. The present invention also relates to a method of using a crane arrangement.

### BACKGROUND

Cranes are widely used in various industry sectors, including construction, shipping, and logistics, for their ability to lift and move heavy loads. However, traditional crane systems often lack sophisticated safety features that prevent accidents and ensure operational efficiency, particularly when the crane operates in proximity to obstacles or workers. The present invention addresses these issues by introducing a crane arrangement with an integrated distance measurement arrangement and operator control inputs that enable safer crane operations.

Thus, the safety of the crane operator when operating a loader crane is particularly important. During a loading/unloading procedure, the operator of the crane is typically standing next to the truck mounted crane when operating it and moves around in a crane working area during the operations. The crane operator normally has a radio remote crane manoeuvring unit for operating the crane. There have been a number of accidents where the operator has been unable to avoid getting stuck between the tip of the crane, or a tool at the tip of the crane, and another object. This could e.g. be the result of unintentionally pressing levers of the remote crane manoeuvring unit due to slipping or tripping over some obstacle. By limiting or stopping the crane movement when the operator is close to the movable crane tip, these accidents may be avoided.

Various solutions have been suggested in the prior art, and having the intention for avoiding the above-described situations.

For example, in EP3556712B, this has been addressed by selecting and controlling safety spaces with the manoeuvring unit wherein the manoeuvring unit itself could be used as a basis for defining one of these safety spaces.

U.S. Pat. No. 9,269,255B2 relates to worksite proximity warning configured to generate an alarm if first and second safety envelopes come in contact.

US20130299440A1 discloses a tower crane with RFID technology for load management and collision avoidance. It employs at least four RFID components, including readers and tags, to measure distances and positions, ensuring safe operations. A key feature is its collision avoidance system, which continuously monitors the crane's surroundings using tag scanners. The crane will automatically stop if the load gets too close to other objects, preventing collisions.

CN113682965A discloses an automatic safety control system for crane operations, ensuring safety by monitoring personnel positions in the crane operating area. The crane utilizes distance meters and a wearable sub-platform to track personnel movement, creating a coordinate system. A control cabinet and external safety control server collaborate to adjust crane operations based on specified distance thresholds between the crane and personnel. If distances fall below these thresholds, the system issues a warning, slows down, or stops crane operations to prevent accidents and ensure personnel safety.

US20220234867A1 discloses a system control device for mobile cranes utilizes GNSS technology and operator input to gather data on crane position, site topography, load weight, and operating conditions. The system calculates the crane's movable range and overlays it onto a 2D or 3D image of the work site displayed on a monitor. The device can be located inside the crane cabin or on a remote terminal, which includes communication devices and GNSS receivers for precise positioning and control of the crane.

Although the presently known solutions are stated to provide operator safety, there is still room for improvements to provide even higher operator safety and at the same time enable the operator to have full control of the crane loading/unloading during the entire loading/unloading procedure.

Thus, the object of the present invention is to achieve an improved crane arrangement providing high operator safety and high operator controllability of the entire loading/unloading procedure.

### SUMMARY

The above-mentioned objects are achieved by the present invention according to the independent claims.

Preferred embodiments are set forth in the dependent claims.

The crane arrangement defined herein is an innovative system that fosters operational safety and responsiveness in crane operations. By integrating a distance measurement arrangement with user-defined controls and safety protocols, this invention optimizes performance while effectively managing potential hazards associated with lifting activities. The unique features, including cautious operation modes and continuous monitoring capabilities, make this crane arrangement a significant advancement in the field of crane technology, ensuring both operator and workplace safety.

The present invention provides a crane arrangement configured to improve safety during operation, by comparing the working distance between a crane manoeuvring unit and a designated location on the crane's movable arm with predefined safety distances. The crane arrangement will inhibit movements when safety thresholds are breached unless specific operator inputs indicate the need to proceed with caution.

The method for operating the crane arrangement offers a comprehensive safety framework that utilizes continuous distance monitoring in conjunction with operator inputs to maintain safe crane operations. By integrating systematic controls, measurement protocols, and responsive actions, this method enhances operational safety and efficiency, thereby addressing critical issues faced in traditional crane handling practices.

The present invention as defined by the independent claims underscores the importance of real-time data feedback and operator awareness in mitigating risks associated with lifting operations.

Different zones are defined based on the distance from the crane tip, the action in response to detecting a working distance mapping the manoeuvring unit into one of these zones may e.g. be to issue an alert to the operator, to slow down the speed of movement of the crane tip, or to stop the movement completely.

When the operator is measured to be in a dangerous situation, the crane may hence stop its movement. But in some cases, these riskier operations are needed and a strict prevention does not solve the problem for the crane operator. So, the present invention introduces an opportunity for the operator to restart the movement by first putting affected inputs in neutral position on the manoeuvring unit and then either move away from the tip of the crane or by using the manoeuvring unit to confirm that operation is wanted despite close proximity between tip and operator.

There are also various options for building on top of this functionality, e.g. to only allow for a limited speed of movement after overriding a warning and maintaining the position within the dangerous zone.

### BRIEF DESCRIPTION OF THE DRAWINGS

FIG. 1 is a schematic illustration of a vehicle provided with a crane arrangement according to the present invention.

FIG. 2 is a schematic illustration showing different safety distances in relation to distance measurement units according embodiments of the present invention.

FIG. 3 is a flow diagram illustrating the method defined in the independent method claim.

### DETAILED DESCRIPTION

The crane arrangement, and the method of using the crane arrangement, will now be described in detail with references to the appended figures. Throughout the figures the same, or similar, items have the same reference signs. Moreover, the items and the figures are not necessarily to scale, emphasis instead being placed upon illustrating the principles of the invention.

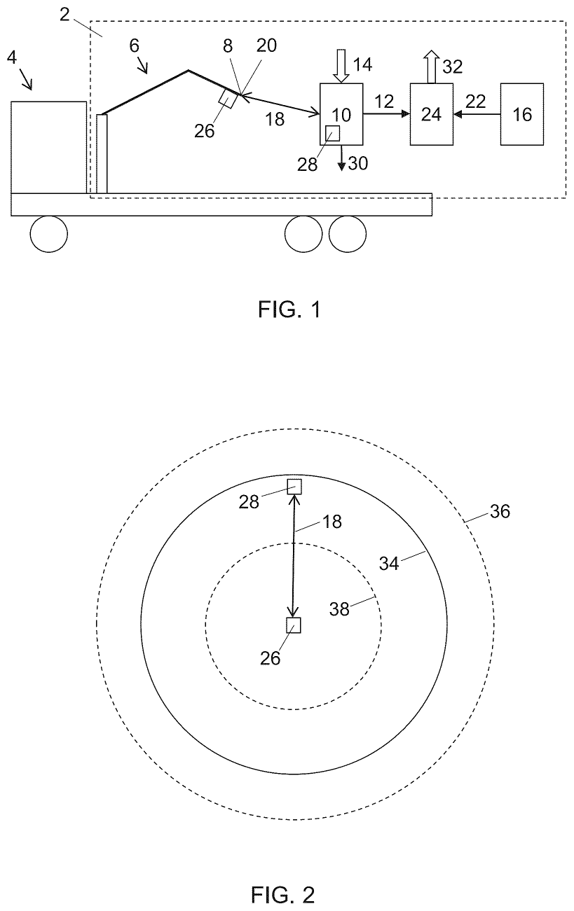

With reference to the schematic illustration shown in FIG. 1, the invention relates to a crane arrangement 2 arranged in relation to a vehicle 4, e.g. a truck or lorry for load handling or transportation.

The crane arrangement 2 comprises a movable arm 6 comprising a plurality of crane booms including a final crane boom with a crane boom tip 8. Conventionally, the movable arm is attached to a vertical crane pillar, and the crane booms may comprise one or many telescopically extendable booms.

The crane arrangement 2 further comprises a crane manoeuvring unit 10 arranged to generate crane operation commands 12, such as commands for movements of the movable arm 6, based on received crane operation inputs 14 by an operator of the crane arrangement 2. The crane manoeuvring unit 10 is conventionally a hand-held unit provided with numerous input members, e.g. levers and/or buttons, that the operator uses for applying the crane operation inputs, and also output members, e.g. a display, lamps, and audible/tactile members. Preferably, the crane manoeuvring unit 10 is provided with means for remote communication with other units of the crane arrangement, e.g. by using radio or optical communication technology.

Furthermore, the crane arrangement comprises a distance measurement arrangement 16 that is critical to the safety features of the crane. The distance measurement arrangement 16 is configured to measure and determine a straight-line working distance 18 between the crane manoeuvring unit 10 and a predetermined location 20 at the movable arm 6, and to generate a distance signal 22 in dependence thereto that informs a crane controller 24 of the current working distance.

The crane arrangement also comprises the crane controller 24 arranged to monitor and control the movements of the movable arm 6 in response to crane operation commands 12 received from the crane manoeuvring unit 10 and of the distance signal 22 from the distance measurement arrangement 16. The crane controller 24 is configured to generate control signals 32 to control the movements of the movable arm, and preferably also to control the operation of a tool attached to the crane boom tip 8. The control signals are conventionally applied to various actuators, e.g. hydraulic actuators, electro-hydraulic actuators or electro-mechanical actuators, provided in relation to the movable arm.

The crane controller 24 is configured to compare the working distance 18 to a first predetermined safety distance 34 (see FIG. 2), and if the working distance 18 is shorter than the first predetermined safety distance 34, the crane controller 24 is arranged to automatically limit or stop any crane movements to prevent accidents.

The manoeuvring unit 10 is configured to receive, from the operator, a crane operation input for continued operation, and if it is determined that the working distance 18 is shorter than the first predetermined safety distance 34 and if a crane operation input for continued operation is received by the manoeuvring unit 10, the crane controller 24 is arranged to activate a cautious operation mode that enables restricted movements of the movable arm 6 defined by a set of movement limitation rules.

Thus, according the present invention, the manoeuvring unit 10 can receive operator input for continued operation. If a cautionary condition is detected (the working distance being shorter than the first safety distance) but the operator chooses to maintain operations by providing a specific input, the crane controller 24 activates a cautious operation mode. In this mode, the movements of the movable arm 6 are still allowed but are restricted and governed by a set of movement limitation rules designed to ensure safety.

The technical solution is based on providing a distance measurement arrangement capable of continuously determining the working distance. Various distance measurement solutions exist. One such solution is implemented by providing at least two units and continuously measuring the distance between these units by applying radio time of flight technology. This technology provides that an accurate distance can be calculated, typically with a precision in range of one to ten centimetres. Alternatively, the distance measurement could be based on other technologies such as e.g. ultrasound or vision-based systems.

According to an embodiment, the distance measurement arrangement 16 comprises a first distance measurement unit 26 mounted at the predetermined location 20 at the movable arm 6, and a second distance measurement unit 28 provided in the crane manoeuvring unit 10. Advantageously, the predetermined location 20 is at the final crane boom, preferably close to, or at, said crane boom tip 8. This set-up is schematically illustrated in FIG. 1.

Note that in FIG. 1, for sake of simplicity, the first and second distance measurement units 26, 28 are shown as units being separate from the box designating the distance measurement arrangement 16, even though they are part of that arrangement.

Preferably, the first and second measurement units are configured to apply the above discussed radio time of flight technology. The radio time of flight technology may be based on a round trip time between two measurement units wherein one measurement unit transmits a first signal and the other unit transmits another signal in response to receiving the first signal.

According to another embodiment, one of the movement limitation rules comprises a rule resulting in reduced maximum allowed speed of the movable arm 6, or a part of the movable arm 6. Examples of such parts of the movable arm 6, may e.g. be the tip of the last boom of the movable arm, a tool at the tip of the last boom of the movable arm, or one of the booms of the movable arm.

According to still another embodiment, the crane controller 24 is further configured to compare the working distance 18 to a second predetermined safety distance 36 (see FIG. 2), being longer than the first predetermined distance 34. If the working distance 18 is shorter than the second predetermined safety distance 36 and longer than the first predetermined distance 34, the crane controller 24 is configured to initiate a deacceleration of the crane movements according to a predetermined deacceleration rule in the set of movement limitation rules.

According to another embodiment, the set of movement limitation rules comprises a movement limitation rule comprising a further reduced maximum allowed speed of the movable arm 6, or a part of the movable arm 6, for working distances 18 being shorter than a third predetermined safety distance 38 (see FIG. 2), wherein the third predetermined safety distance is shorter than the first predetermined safety distance.

In another embodiment, the crane controller 24 is provided with a set of predetermined safety distances including the first predetermined safety distance, and that each of the predetermined safety distances has one or more designated movement limitation rule in the set of movement limitation rules, and wherein the predetermined safety distances are variable in relation to the working condition. An operator or a person setting up or monitoring an equipment or fleet of equipment with a crane arrangement according to the invention may hence define and/or select different safety distances and also different movement limitation rules for the arrangement, through a user interface such as a crane manoeuvring unit (10) or another interface to the crane arrangement.

Various detailed rules are defined according to the above embodiments that govern the crane's operations based on the working distance. For instance, should the measured working distance fall within specific ranges relative to safety distances, the crane controller may impose lower maximum speeds for the movable arm 6 to promote safety. Furthermore, as distances approach the third predetermined safety distance 38, further restrictions can be applied.

In another embodiment, the distance measurement arrangement 16 is configured to measure and determine the working distance 18 at a predetermined measurement rate. Preferably, the predetermined measurement rate is in the range of 5-100 measurements/second.

According to another embodiment, the manoeuvring unit 10 is configured to receive, from the operator, a crane operation input for monitoring the working distance 18 between the manoeuvring unit 10 and the predetermined location 20 at the movable arm 6. In response of receiving such crane operation input, a distance monitoring operation mode is activated, resulting in that the distance measurement arrangement 16 is controlled to measure and determine the working distance 8. The determined working distance 8 may e.g. be presented at a display of the crane manoeuvring unit 10.

Preferably, if no measurement of the working distance 18 is performed, or performed at a lower measurement rate than required, despite being in the distance monitoring mode, the crane controller 24 is configured to generate an indication signal 30 and/or stop or deaccelerate movements of the movable arm 6.

In an alternative variation, a further mode is provided. In this mode the crane controller is further arranged to activate a distance monitoring operation mode in response to receiving a crane operation command for monitoring the distance between the first and second distance measurement units, and that the crane controller is further arranged, in the distance monitoring operation mode, to verify that the current working distance between the first and second distance measurement units is being determined to be shorter than the second predetermined safety distance before controlling the movements of the movable arm in response to operation commands received from the manoeuvring unit.

FIG. 2 is a schematic illustration showing the first distance measurement unit 26, e.g. arranged at the crane boom tip 8, and the first 34, second 36, and third 38 predetermined safety distances shown as concentric circles with regards to unit 26. In the illustrated embodiment the second distance measurement unit 28, provided within the manoeuvring unit, that a fictive operator carries, is at a working distance 18 that is shorter than the first predetermined safety distance 34, but longer than the third predetermined safety distance 38. Note that the concentric circles in FIG. 2 are only illustrative and the predetermined distances may equally be illustrated with the second distance measurement unit 28 at the center.

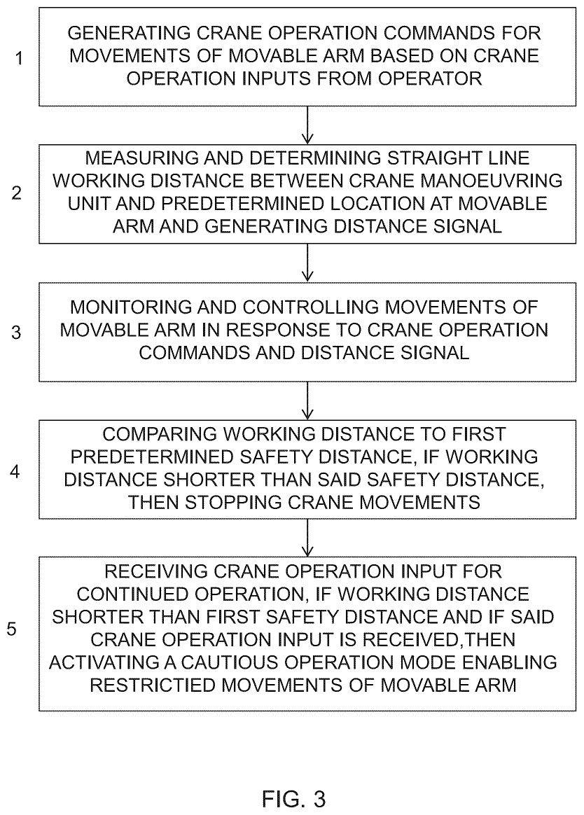

The present invention also relates to a method of using a crane arrangement as defined above. The crane arrangement, and different embodiments of the arrangement, have been described in detail above and it is herein referred to that description. The method will now be described with references to the flow diagram shown in FIG. 3.

The present method is aimed at enhancing the operational safety and efficiency of crane arrangements through a systematic approach that utilizes real-time monitoring of working distances and operator input to manage crane movements effectively.

The invention comprises a method for operating a crane arrangement that encompasses a series of systematic steps to ensure safe handling of loads via real-time monitoring of distances and adherence to predetermined safety protocols, enabling restricted or controlled operations based on distance measurements.

The flow diagram in FIG. 3 shows steps 1-5 described in the following.

### Step 1: Generating Crane Operation Commands

The method begins with the crane manoeuvring unit 10 generating crane operation commands 12 based on inputs 14 received from an operator of the crane arrangement 2. These commands are received by the crane controller 24 which control the movements of the movable arm 6 in response to the commands. The commands hence serve as the foundational trigger for the operational processes of the crane.

### Step 2: Measuring the Working Distance

Subsequently, the distance measurement arrangement 16 measures and determines a straight-line working distance 18 between the crane manoeuvring unit 10 and a predetermined location 20 located on the movable arm 6. The output of this measurement process results in the generation of a distance signal 22 which conveys the current working distance data.

### Step 3: Monitoring and Controlling Movements

Next, the crane controller 24 employs the distance signal 22 to monitor and control the movements of the movable arm 6 in accordance with the crane operation commands 12 received. This continuous feedback loop ensures that movements are conditional upon both the operator's commands and real-time distance data.

Step 4: Comparing with Safety Distances

The crane controller 24 then performs a critical comparison of the measured working distance 18 against a predetermined first safety distance 34. Should the working distance be shorter than this first safety distance, the crane movements will be halted automatically as a precautionary measure, preventing potential accidents.

### Step 5: Operator Input for Continued Operation

A distinctive feature of the method according to the present invention, is the allowance for operator input despite the working distance being shorter than the first safety distance. Thus, if the operator inputs a command for continued operation while the working distance 18 remains shorter than the first predetermined safety distance 34, the crane controller 24 activates a cautious operation mode. This mode allows for restricted movements of the movable arm 6, which are governed by a predetermined set of movement limitation rules.

In the following, some embodiments of the method are listed. These have the same technical features and advantages as for the corresponding features of the hydraulic arrangement described above. Consequently, these technical features and advantages are not repeated or explained anew in order to avoid unnecessary repetition.

### Enhanced Safety Features

### Step 6: Deacceleration of Crane Movements

According to an embodiment, an additional layer of safety is introduced. The crane controller 24 compares the working distance 18 with a second predetermined safety distance 36, which is longer than the first safety distance 34. If the working distance is found to be shorter than the second predetermined safety distance 36 but longer than the first 34, the crane controller will initiate a gradual deacceleration of the crane movements, as defined by a predetermined deacceleration rule.

### Step 7: Movement Limitation Rules

According to a further embodiment it is outlined rules that restrict the maximum allowed speed of the movable arm 6. In scenarios where the working distance 18 is shorter than a third predetermined safety distance 38—which is also defined to be shorter than the first safety distance 34—additional speed reductions are applied, enhancing operational safety during critical phases of movement.

### Monitoring Rate and User Inputs

### Step 8: Measurement Rate of Working Distance

In a further embodiment, the distance measurement arrangement 16 is configured to determine the working distance 18 at a predetermined measurement rate. This feature ensures that the crane controller receives timely data to ascertain continuous crane operations.

### Step 9: Distance Monitoring Operation Mode

Lastly, according to still another embodiment, the method allows the operator to input a command to initiate a distance monitoring operation mode. In this mode, the distance measurement arrangement 16 is activated to measure the working distance 18 continuously. If the working distance is not measured, or if measurements fall below the required rate, the crane controller 24 generates an indication signal 30 to alert the operator. Additionally, it may halt or decelerate crane movements automatically, ensuring a response to potential monitoring failures.

The present invention is not limited to the above-described preferred embodiments. Various alternatives, and modifications may be used, as an example, the distance measurement arrangement (16) may comprise additional distance measurement units (adding to the first and second units mentioned) which would enable defining a plurality of working distances and more advanced comparison to multiple safety distance(s) for triggering a stop of crane movements and activation of the cautious mode. Therefore, the above embodiments should not be taken as limiting the scope of the invention, which is defined by the appending claims.

1. Crane arrangement arranged in relation to a vehicle, the crane arrangement comprising:
a movable arm comprising a plurality of crane booms including a final crane boom with a crane boom tip;
a crane manoeuvring unit arranged to generate crane operation commands, such as commands for movements of the movable arm, based on received crane operation inputs by an operator of the crane arrangement;
a distance measurement arrangement configured to measure and determine a straight line working distance between said crane manoeuvring unit and a predetermined location at said movable arm, and to generate a distance signal in dependence thereto, and
a crane controller arranged to monitor and control the movements of the movable arm in response to crane operation commands received from the crane manoeuvring unit and of said distance signal from the distance measurement arrangement,
wherein said crane controller is configured to compare the working distance to a first predetermined safety distance, and if said working distance is shorter than said first predetermined safety distance, the crane controller is arranged to stop crane movements, wherein said manoeuvring unit is configured to receive, from the operator, a crane operation input for continued operation, and if it is determined that said working distance is shorter than said first predetermined safety distance and if a crane operation input for continued operation is received by said manoeuvring unit, the crane controller is arranged to activate a cautious operation mode that enables restricted movements of the movable arm defined by a set of movement limitation rules.

2. The crane arrangement according to claim 1, wherein the distance measurement arrangement comprises a first distance measurement unit mounted at said predetermined location at said movable arm, and a second distance measurement unit provided in said crane manoeuvring unit.

3. The crane arrangement according to claim 1, wherein said predetermined location is at said final crane boom, preferably close to, or at, said crane boom tip.

4. The crane arrangement according to claim 1, wherein one of said movement limitation rules comprises a rule resulting in reduced maximum allowed speed of the movable arm, or a part of the movable arm.

5. The crane arrangement according to claim 1, wherein the crane controller is further configured to compare said working distance to a second predetermined safety distance, being longer than said first predetermined distance, wherein if said working distance is shorter than the second predetermined safety distance and longer than the first predetermined safety distance, the crane controller is configured to initiate a deacceleration of the crane movements according to a predetermined deacceleration rule in the set of movement limitation rules.

6. The crane arrangement according to claim 1, wherein the set of movement limitation rules comprises a movement limitation rule comprising a further reduced maximum allowed speed of the movable arm, or a part of the movable arm, for working distances being shorter than a third predetermined safety distance, wherein the third predetermined safety distance is shorter than the first predetermined safety distance.

7. The crane arrangement according to claim 1, wherein said distance measurement arrangement is configured to measure and determine the working distance at a predetermined measurement rate.

8. The crane arrangement according to claim 1, wherein said manoeuvring unit is configured to receive, from the operator, a crane operation input for monitoring the working distance between said manoeuvring unit and said predetermined location at said movable arm, and in response of receiving such crane operation input, a distance monitoring operation mode is activated, resulting in that said distance measurement arrangement is controlled to measure and determine the working distance.

9. The crane arrangement according to claim 8, wherein if no measurement of the working distance is performed, or performed at a lower measurement rate than required, despite being in the distance monitoring mode, the crane controller is configured to generate an indication signal and/or stop or deaccelerate movements of the movable arm.

10. The crane arrangement according to claim 1, wherein said crane controller is provided with a set of predetermined safety distances including said first predetermined safety distance, and that each of said predetermined safety distances has a designated movement limitation rule in said set of movement limitation rules, and wherein said predetermined safety distances are variable in relation to the working condition.

11. A method of using a crane arrangement according to claim 1, the method comprising:
generating crane operation commands, by the crane manoeuvring unit, such as commands for movements of the movable arm, based on received crane operation inputs by an operator of the crane arrangement;
measuring and determining, by the distance measurement arrangement, a straight line working distance between said crane manoeuvring unit and a predetermined location at said movable arm, and generating a distance signal in dependence thereto,
monitoring and controlling, by the crane controller, the movements of the movable arm in response to crane operation commands and of said distance signal, and
comparing, by the crane controller, the working distance to a first predetermined safety distance, and if said working distance is shorter than said first predetermined safety distance, stopping crane movements, wherein the method further comprises:
receiving, by the crane manoeuvring unit, a crane operation input for continued operation from the operator, and if it is determined that said working distance is shorter than said first predetermined safety distance and if a crane operation input for continued operation is received, activating, by the crane controller, a cautious operation mode enabling restricted movements of the movable arm defined by a set of movement limitation rules.

12. The method according to claim 11, wherein the method comprises comparing, by said crane controller, said working distance to a second predetermined safety distance, being longer than said first predetermined distance, and wherein if said working distance is shorter than the second predetermined safety distance and longer than the first predetermined safety distance, the method comprises initiating a deacceleration of the crane movements according to a predetermined deacceleration rule in the set of movement limitation rules.

13. The method according to claim 11, wherein one of said movement limitation rules comprises a rule resulting in reduced maximum allowed speed of the movable arm, or a part of the movable arm, and, optionally, wherein the set of movement limitation rules further comprises a movement limitation rule comprising a further reduced maximum allowed speed of the movable arm, or a part of the movable arm, for working distances being shorter than a third predetermined safety distance, wherein the third predetermined safety distance is shorter than the first predetermined safety distance.

14. The method according to claim 11, comprising measuring and determining the working distance by said distance measurement arrangement, at a predetermined measurement rate.

15. The method according to claim 11, comprising receiving, by the manoeuvring unit, a crane operation input, from the operator, for monitoring the working distance between said manoeuvring unit and said predetermined location at said movable arm, and in response of receiving such crane operation input, activating a distance monitoring operation mode, resulting in measuring and determining the working distance, by said distance measurement arrangement, and wherein if no measurement of the working distance is performed, or performed at a lower measurement rate than required, despite being in the distance monitoring mode, generating an indication signal and/or stopping or deaccelerating movements of the movable arm, by the crane controller.
